(19) United States
(12) Patent Application Publication
(10) Pub. No.: US 2026/0157292 A1
(43) Pub. Date: Jun. 11, 2026

(54) A GROWTH SUBSTRATE BLOCK AND METHOD OF MANUFACTURE THEREOF

(71) Applicant: LES SOLUTIONS HORTICOLES HERBIAERA INC., Québec (CA)

(72) Inventors: Alexandre BOUCHER-DODDRIDGE, St-Antoine-de-Tilly (CA); Anthony BISSON, Sainte-Marie (CA); Karine BOUCHARD, Granby (CA); Anie DESAUTELS, Saint-Hugues (CA); Thomas HEER, St-Narcisse (CA)

(73) Assignee: LES SOLUTIONS HORTICOLES HERBIAERA INC., Québec, QC (CA)

(21) Appl. No.: 18/683,197

(22) PCT Filed: Aug. 15, 2022
(86) PCT No.: PCT/CA2022/051235

§ 371 Date: Feb. 12, 2024

Related U.S. Application Data
(60) Provisional application No. 63/260,242, filed on Aug. 13, 2021.

(51) Int. Cl. A01G 27/06; A01G 9/24; A01G 24/15; A01G 24/23; A01G 24/25; A01G 24/28; A01G 24/48; A01G 24/60; C05F 3/00; C05F 11/00; C05G 5/40

(52) U.S. Cl. CPC A01G 27/06; A01G 9/247; A01G 24/15; A01G 24/23; A01G 24/25; A01G 24/28; A01G 24/48; A01G 24/60; C05F 3/00; C05F 11/00; C05G 5/40

(57) ABSTRACT

A growth substrate block is provided for sustaining the growth of a plant or fungi based on capillary watering, including a growth medium defining a network of micropores and macropores allowing water to flow by capillarity and air to circulate within the growth medium, and a binding material to maintain cohesion of the growth medium. The growth substrate block can be sized for insertion into a self-watering recess of a container to make space for a root system up to plant maturity. A self-watering plant growth assembly includes a container having a recess being supplied with water via capillary action, and the growth substrate block being inserted in the recess. A method to produce a growth substrate block sustaining the growth of a plant or fungi based on capillary watering is further provided.

### TECHNICAL FIELD

The present techniques relate to the field of passive hydroponics, and more particularly to a growth substrate block that can be configured for insertion in a self-watering recess of a container to sustain plant growth, and a related method of manufacture.

### BACKGROUND

Passive hydroponics involves conducting water and fertilizer to a root system of a plant via a porous medium by capillary action. Multiple compositions for a growth medium are available to sustain growth of the root system and related plant. In addition to retaining and conducting water adequately, the growth medium needs to give access to air and micronutrients to the root system.

A typical growth medium for passive hydroponics is deprived in soil and high in coconut husk fibers. Regulating growth conditions to sustain optimal plant growth in a passive hydroponic growth medium can be difficult. Systems for monitoring plant growth and regulate growing conditions have been developed but can be complex and costly. The size of the available substrate is also generally not sufficient to allow full growth of the plant root system and to sustain the growth of the plant up to maturity. In addition, known growth substrates are difficult to manipulate by hand or machine because they tend to brittle.

There is thus still a need for a growth medium that can overcome at least some of the drawbacks of what is known in the field and sustain optimal plant growth.

### SUMMARY

In one aspect, there is provided a growth substrate block for sustaining the growth of a plant or fungi based on capillary watering, the growth substrate block comprising: a growth medium including an organic material, the growth medium defining a network of micropores and macropores allowing water to flow by capillarity and air to circulate within the growth medium; and a binding material provided as a binding layer onto at least a portion of an exterior surface of the growth medium to maintain cohesion of the growth medium.

In some implementations, the organic material of the growth substrate block is peat moss, chernozemic soil (black earth), compost, coconut husk chips, coconut fibers, wood fibers, hemp fibers, biochar or any mixtures thereof.

In some implementations, the growth medium further comprises at least one of a mineral material, a fertilizing material and a wetting agent. The mineral material can be sand, clay, lime, perlite, rock wool or any mixtures thereof. Optionally, the clay can be vermiculite, diatomite, kaolinite, bentonite or any combination thereof. The wetting agent is a media surfactant.

In some implementations, the growth medium comprises the organic material, the mineral material, and the wetting agent. Optionally, the growth medium comprises soil, peat moss, coconut fibers, kaolinite, and perlite.

In some implementations, the growth medium further comprises the fertilizing material. Optionally, the fertilizing material is a slow-release fertilizer.

In some implementations, the fertilizing material is an organic fertilizing material. Optionally, the organic fertilizing material is insect meal, animal manure of a combination thereof.

In some implementations, the binding material comprises at least one binding agent being latex, polylactic acid (PLA), clay, vinylic glue, rosin glue, sorbitol, molasses powder, Stabifix®, cardboard paste, collagen, oil epoxides, or any mixtures thereof. For example, the clay can be bentonite, kaolinite or any mixtures thereof. Optionally, the binding material can include or be a bio-glue resulting from radical polymerization of itaconic acid with and without glycerol, radical polymerization-polycondensation of itaconic acid with glycerol, or cationic and thermal polymerization of polyunsaturated vegetable oils.

In some implementations, the binding layer is provided on a side surface and a bottom surface of the growth medium. Optionally, the binding layer is permeable to water.

In some implementations, the growth medium comprises an additional binding agent that is homogeneously distributed within the growth medium.

In some implementations, the growth substrate block further comprises at least one plant seed. In other implementations, the growth substrate block further comprises at least one spore of fungi.

In some implementations, the growth medium has a density between 0.1 g/cm³ and 1 g/cm³ (in a dried state).

In some implementations, the growth medium can include at least 55 wt %, 65 wt %, 75 wt % or 80 wt % of the organic material.

In some implementations, the binding material represents at most 5 wt %, at most 3 wt %, at most 2 wt % or at most 1 wt % of a total weight of the growth medium.

In some implementations, the growth substrate block is biodegradable after a period of use of the growth substrate block upon exposure to temperature conditions allowing biodegradability. Optionally, the growth medium is biodegradable after a period of use of the growth substrate block upon exposure to temperature conditions allowing biodegradability. Optionally, the binding material is biodegradable after a period of use of the growth substrate block upon exposure to temperature conditions allowing biodegradability.

In some implementations, the growth substrate block is sized in accordance with dimensions of a root system at plant maturity, optionally having a volume of the growth substrate block is between 250 cm³ and 2000cm³.

In some implementations, the growth substrate block has a parallelepipedal shape, a frustoconical shape, or a cylindrical shape.

In another aspect, there is provided a method to produce a growth substrate block sustaining the growth of a plant or fungi based on capillary watering, the method comprising: forming a growth premix including an organic material; mixing the growth premix to produce a homogeneously distributed growth premix; adding water to the homogeneously distributed growth premix to form a wet premix; molding the wet premix into a shape that is complementary to the self-watering recess of the container to produce a wet growth medium; forming a binding layer made of a binding material onto at least a portion of an exterior surface of the wet growth medium to form a wet growth substrate block, and drying the wet growth substrate block to form the growth substrate.

In some implementations, the steps of forming the substrate premix and mixing the substrate premix are performed simultaneously.

In some implementations, the steps of mixing the growth premix and adding water to the homogeneously distributed growth premix are performed simultaneously.

In some implementations, molding the wet premix comprises compacting the wet premix into a mold of given shape and size. Optionally, molding the wet premix comprises forming seed holes in the surface of the wet growth medium.

In some implementations, the forming of the growth premix comprises providing the organic material together with at least one of a mineral material, a fertilizing material and a wetting agent.

In some implementations, forming the binding layer comprises spraying a solution comprising at least one binding agent onto the at least a portion of the exterior surface of the wet growth medium.

In some implementations, the method comprises forming the solution comprising the at least one binding agent by adjusting a concentration of the binding agent in the solution.

In some implementations, the method further comprises positioning at least one plant seed within an upper portion of the growth substrate block. Optionally, the positioning of the at least one plant seed is performed after drying. Optionally, the drying is performed to produce the growth substrate block at 0 to 3 % of a water absorption capacity thereof. Optionally, the drying is performed at a temperature between 5° C. and 40° C.

In some implementations, the method further comprises maintaining a temperature of the growth substrate block at most 18° C. during a storage period.

In another aspect, there is provided a self-watering plant growth assembly comprising: a container comprising a water tank that is supplied with water, a recess and a porous medium that provides water from the water tank into the recess via capillary action; and a growth substrate block as defined herein, or as produced by the method as defined herein, which is inserted in the recess of the container to sustain plant growth upon receiving the water that is provided from the water tank via the porous medium.

While the invention will be described in conjunction with example embodiments, it will be understood that it is not intended to limit the scope of the invention to such embodiments. On the contrary, it is intended to cover all alternatives, modifications and equivalents as may be included as defined by the present description. The objects, advantages and other features of the present invention will become more apparent and be better understood upon reading of the following non-restrictive description of the invention, given with reference to the accompanying drawings.

### BRIEF DESCRIPTION OF THE DRAWINGS

Implementations of the growth substrate block, related assembly and related method of manufacture are represented in and will be further understood in connection with the following figures.

FIG. 1 is a schematic representation of a self-watering plant growth assembly (from the formation of the assembly to the plant growth phase) including a growth substrate block that is inserted in a self-watering recess of a container.

FIG. 2 is a schematic process flow diagram showing general steps of the method for producing a growth substrate block as encompassed herein.

FIG. 3 is a schematic representation of an implementation of the mixing step of the present method.

FIG. 4 is a schematic representation of an implementation of the molding step of the present method.

FIG. 5 is a schematic representation of an implementation of the binding, drying, and packaging steps of the present method.

### DETAILED DESCRIPTION

The present techniques relate to a growth substrate block having a size and a composition providing physico-chemical properties tailored to allow full growth of a plant root system and to sustain the growth of the plant up to maturity. The growth substrate block is particularly adapted to passive hydroponics, and more particularly adapted for insertion in a recess of a container that is used for plant growth.

The growth substrate or growth substrate block as encompassed herein can be referred to a ready-to-grow substrate block because the growth substrate block is ready for a direct use to start plant growth upon insertion, for example, in the recess of a plant container.

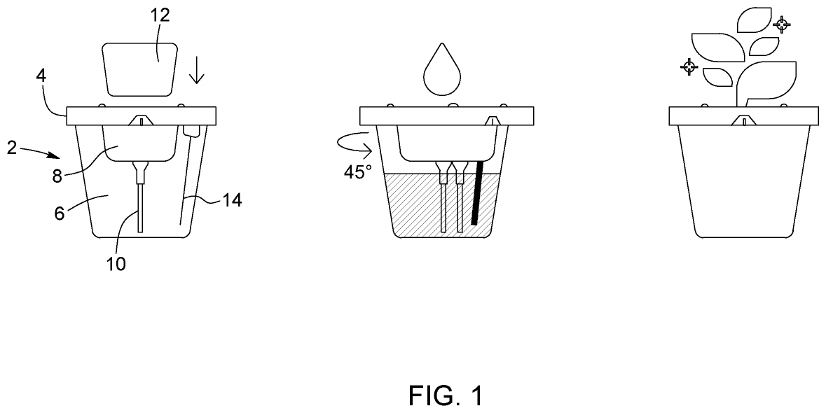

Referring to FIG. 1, the ready-to-grow substrate block is a molded substrate that can fit into a recess of a container, and that is able to sustain the growth of a plant to maturity upon receiving water. The ready-to-grow substrate block is particularly configured for storing and releasing water by capillary action to a root system of the growing plant. The water can be available from a water chamber of the same container and can be provided to the substrate, e.g., via an inert porous medium that extends from the recess of the container to the water chamber and conveys water also by capillary action.

The growth substrate that is shaped as a block includes a combination of a growth medium providing pores and cavities of various sizing to reversibly store air and water, at least one plant seed or fungi spore, and at least one binding agent selectively provided on at least a portion of an exterior surface of the growth medium to ensure cohesion of the growth medium and form the growth substrate block.

### Growth Medium

The growth medium is composed and structured to provide the necessary capillary action to displace water towards the roots of the plant. The growth medium defines pockets of empty space that can receive air and/or water, and provides space for the roots to grow. The growth medium is made of at least one component that can have pores which contribute to the formation of a network of pockets for air and/or water. More particularly, the components of the growth medium and their distribution to form the growth medium are adapted to provide a balanced network of micropores and macropores, with the micropores allowing water to flow by capillarity towards the roots of the plant and the macropores allowing air to circulate within the growth medium. The ratio of micropores versus macropores is selected to provide a balance between water and oxygen to achieve maturity of the root system and optimal production of leaves and fruits. The growth medium can be provided in particulate form having a particle size of at most 10 mm.

The at least one component forming the growth medium is further chosen to be biodegradable. However, the growth medium is composed not to reduce in volume or decompose during the storage lifetime of the substrate and in absence of added water. The storage lifetime of the growth substrate block is generally related to the period during which the seeds are able to maintain a satisfactory germination efficiency, and can typically be from one to four years.

More particularly, the growth medium includes an organic material to provide for plant-based fibers. The growth medium can further include at least one of a mineral material, a fertilizing material and a wetting agent. In some implementations, the growth medium can include the organic material and the mineral material. In some implementations, the growth medium can include the organic material and the fertilizing material. In some implementations, the growth medium can include the organic material, the mineral material and the wetting agent. In some implementations, the growth medium can include the organic material, the mineral material, the fertilizing material and the wetting agent. For example, the growth medium can include at least 55 wt %, 65 wt %, 75 wt % or 80 wt % of the organic material. For example, the growth medium can include between 75 and 80 wt % of the organic material, between 10 and 18 wt % of the mineral material, and the balance being at least one of the wetting agent and the fertilizing material.

It should be noted that the amounts of components of the growth medium are given with respect to a total weight of the growth medium on a dry basis, i.e., in absence of added water. However, the growth substrate block can include added water. Indeed, water can be added to the components of the growth medium when forming the growth substrate block to facilitate cohesion of the components of the growth medium into a given shape. The mixture of the growth medium and water can be referred to as a growth premix. For example, upon being formed and before any drying has occurred, the wet growth substrate block (including the wet growth medium and the at least one binding agent provided as a layer) can be said to include between 40 and 50 wt % of water.

The organic material of the growth medium can be readily available or derived from terrestrial or aquatic environments, and includes organic compounds that can originate from organisms (such as plants and/or animals) and their waste products. The organic material can be peat moss, chernozemic soil (black earth), compost, coconut husk chips, coconut fibers, wood fibers, hemp fibers, biochar or any mixtures thereof. In some implementations, the organic material can include peat moss and chernozemic soil. In some implementations, the organic material can include peat moss, compost and chernozemic soil. For example, the growth medium can include at least 70% of peat moss, chernozemic soil, compost or a combination thereof.

When present, the mineral material of the growth medium can be sand, clay, lime, perlite, rock wool, or any mixtures thereof. For example, the clay can be vermiculite, diatomite, kaolinite, bentonite or any combination thereof. The mineral material is chosen to enhance porosity, aeration, and moisture retention of the growth medium. Once wetted, the mineral material can further facilitate cohesion of the growth medium in a given shape. The wetting agent can be a media surfactant (also referred to as a conductor) improving the wettability of the growth medium.

The fertilizing material can be further added to provide nutriments that are beneficial to the growth of the roots and associated plant/fruit/fungi. When present, the fertilizing material of the growth medium can be a naturally occurring or synthesized material including or releasing at least one of nitrogen, phosphorus, potassium, calcium, magnesium, sulfur, bore, copper, iron, manganese, molybdenum, and zinc. For example, the fertilizing material of the growth medium can include gypsum or iron sulfate. More particularly, the fertilizing material can include or be a slow-release fertilizer. For example, bone meal is a slow-release fertilizer that can gradually release phosphorus into the growth medium. In another example, any insect meal or animal manure can be used to further fertilize the organic material of the growth medium. Advantageously, slow-release fertilizer can ensure that an amount of fertilizing material is provided to the plant during the useful/serviceable life of the substrate block.

In some implementations, the fertilizing material can represent at most 5 wt % of the growth medium (dry basis). It should be noted that the type of fertilizing material and the amount thereof can differ from one substrate to another in accordance with the species of plant to be grown. For example, the fertilizing material can be at most 1 wt % when sustaining growth of plants like herbs. In another example, the fertilizing material can be at most 5 wt % when sustaining growth of plants like small size fruit plants (cherry tomatoes, peppers, etc.).

It should further be noted that the organic material that represents the main portion of the growth medium can have a fertilizing effect, such that both the organic material and additional fertilizing material of the growth medium can contribute to sustaining plant growth. It should further be noted that the growth medium can initially be exempt of additional fertilizing material, and that the fertilizing material can be solubilized in the water that is subsequently provided to the growth substrate block via capillary action from the water tank of the container.

One will understand that the growth medium refers herein to the combination of the above listed components, and being shaped and sized in accordance with a minimal space required for the root system to achieve maturity within the recess of the container. The growth medium can expand in volume upon being wetted. However, the growth medium is designed to have a volume expansion remaining of at most 10%, preferably at most 5 wt % when the growth substrate block is fully hydrated (i.e., 100% of the water absorption capacity of the growth medium is reached).

### Plant Seed

The substrate block further includes at least one seed of a plant or spore of fungi that is provided in the growth medium. The plant seed or fungi spore can be embedded in the growth medium or in contact with an upper surface of the growth medium. The plant seed or fungi spore is typically provided in an upper portion of the growth medium. The at least one seed of a plant or spore of fungi can be provided at a given depth of the growth medium in accordance with the requirements associated with each species of plant or fungi to achieve optimal germination and growth. For example, multiple seeds can be provided in a given volume of the upper part of the growth medium to have optimal spacing between plants. For example, the seeds of the plant can be provided in the upper part of the growth medium to produce microgreens of the plant. In another example, the spore of fungi can be provided as a mat of spores that is positioned in contact with an upper surface of the growth medium.

In some implementations, the plant seed can be a seed of a leaf vegetable such as lettuce, spinach, kale, or chard. In another example, the plant seed can be a seed of a small-fruit plant such as tomato, pepper, or strawberry. In another example, the plant seed can be a seed of a flower plant such as nasturtium, pansy, lavender, yarrow, chrysanthemums, marigold, or wallflower. In another example, the plant seed can be a seed of a carnivorous plant such as dionaea muscipula or sarracenia specie. In another example, the plant seed can be a seed of an herb plant such as coriander, oregano, basil, thyme, parsley, rosemary, chives, mint, sage, anise, dill. It should be noted that the at least one seed can be a plurality of seeds. The plurality of seeds can be multiple seeds of a same species or multiple seeds from different species. For example, the at least one spore of fungi can be a spore of oyster or shiitake mushroom.

The growth substrate block is sized in accordance with the species of the plant or fungi because the substrate has to provide sufficient room for the roots of the plant to grow until maturity of the plant. For example, the substrate block can have a parallelepipedal, frustoconical, or cylindrical shape and provide room for a growing root system. In some implementations and in accordance with the species of plant to be grown, the volume of the substrate block can vary between 250 cm³ and 2000cm³, for example between 500 cm³ and 2000cm³. It should be noted that the provided volume of the substrate block is given for the growth substrate block in a hydrated state (i.e., when water is added to the growth medium).

### Binding Material

The at least one binding agent can be provided as a binding material or as part of a binding material. The binding material is selected to ensure cohesion of the molded growth medium while not impeding displacement of water via capillary action. The binding material of the substrate block can be applied onto at least a portion of the exterior surface of the growth medium in the form of a binding layer being permeable to water. It should be noted that, depending on the composition of the growth medium, certain components of said growth medium, such as clay, can have a binding action and favouring cohesion of the substrate block under certain conditions, for example when humid. However, the growth substrate block further includes the binding material being provided as an external binding layer to maintain cohesion of the growth substrate during packaging, handling and/or transport, i.e., prior to being inserted into the recess of a container.

In some implementations, the binding material can include at least one binding agent that is biodegradable, such that the substrate can be easily disposed and composted with no detrimental environmental impact. Biodegradability of the binding material can be considered as met if, for example, the substrate is sufficiently degraded after 90 days to meet the Biodegradable Products Institute (BPI) standard.

For example, the binding material can be selected not to release any chemical compound that could be detrimental for the environment, prevent the seed from germinating or the plant from growing, such as sulphuric acid or aldehyde.

The at least one binding agent can be a naturally occurring binding agent or a synthesized binding agent that can biodegrade. A naturally occurring binding agent should be understood herein as a component that is naturally sourced in contrast to being chemically synthesized, and that has not been subjected to any secondary or tertiary transformation (i.e., not a second or third generation product). The binding agent can, however, be the result of a primary transformation, such as adjusting the pH to stabilize the binding agent, removing impurities, modifying a particle size distribution, modifying a concentration of the binding agent.

In some implementations, the binding material can represent at most 5 wt %, at most 3 wt %, at most 2 wt % or at most 1 wt % of a total weight of the growth medium.

The binding action can result from the formation of a mechanical bond or a covalent bond between the at least one binding agent and the growth medium. The binding action can also result from the chemical reaction between the at least one binding agent and a component (e.g., the organic material) of the growth medium.

In some implementations, the at least one binding agent can be polylactic acid (PLA), clay, vinylic glue, rosin glue, sorbitol, molasses powder, Stabifix®, cardboard paste, collagen, latex, oil epoxides, or any mixtures thereof. For example, the clay can be bentonite, kaolinite or any mixtures thereof. The binding material can include or be a bio-glue resulting from radical polymerization of itaconic acid with and without glycerol, radical polymerization-polycondensation of itaconic acid with glycerol, or cationic and thermal polymerization of polyunsaturated vegetable oils.

In some implementations, the binding material can include a first binding agent and a second binding agent, with the first binding agent and the second binding agent that can be selected among the components listed above.

The binding material of the substrate block is provided as the binding layer defining at least a portion of the exterior surface of the substrate block. In some implementations, the binding layer extends onto a side surface and a bottom surface of the growth medium, while leaving an upper surface untreated. It should be noted that the bottom surface and the side surface of the growth medium are the ones to be in contact with the recess of the container. The upper surface of the growth medium is the surface from which the plant or fungi will grow in a generally upward direction. More details will be provided in the section detailing method implementations related to the production of the substrate block.

The growth substrate block as defined herein can be used as part of a self-watering plant growth assembly as shown in FIG. 1. The watering plant growth assembly 2 comprises a container 4 comprising a water tank 6 that is supplied with water, a recess 8 and a porous medium 10 that provides water from the water tank 6 into the recess 8 via capillary action. The growth substrate block 12 as defined herein is further inserted in the recess 8 of the container 4 to sustain plant growth upon receiving the water that is provided from the water tank 6 via the porous medium 10. The assembly can further include a sensor 14 for monitoring a level of water in the water tank 6. The assembly can further include a controller (not shown) that triggers the display of a warning message on a local or remote device when the monitored water level reaches a minimal threshold, to warn a user that the water tank should be refilled with water to maintain optimal plant growth via the growth substrate block 12.

### Production of the Substrate Block

In another aspect, there is provided a method to manufacture the growth substrate block. More particularly, there is provided a method to form the growth substrate block that is ready to be inserted in the recess of the container for use to sustain plant/fungus growth via capillary watering.

The growth substrate block is configured for withstanding handling and transport, and for further fitting in the recess of the container. The method includes steps to form and shape the growth medium, to bind the growth medium to maintain its shape, to add at least one plant seed to the growth medium, and thereby produce the growth substrate block. More particularly, the method can include the following steps.

The method includes forming a growth premix including the organic material, and further mixing thereof to achieve a homogeneous distribution within the growth premix. Formation of the growth premix can further include providing at least one of the mineral material, the wetting agent and the fertilizing material. The method further includes adding water to the growth premix to form a wet premix. Addition of water can be performed by mixing simultaneously the components of the growth premix and water.

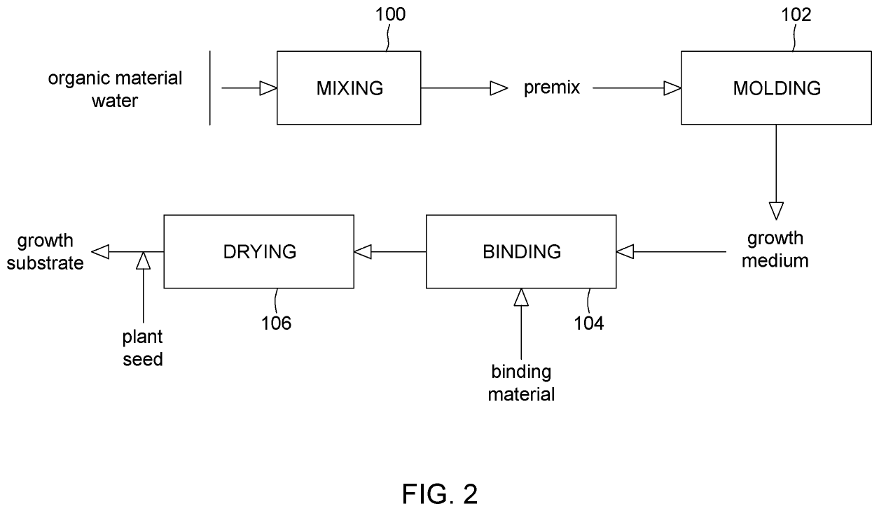

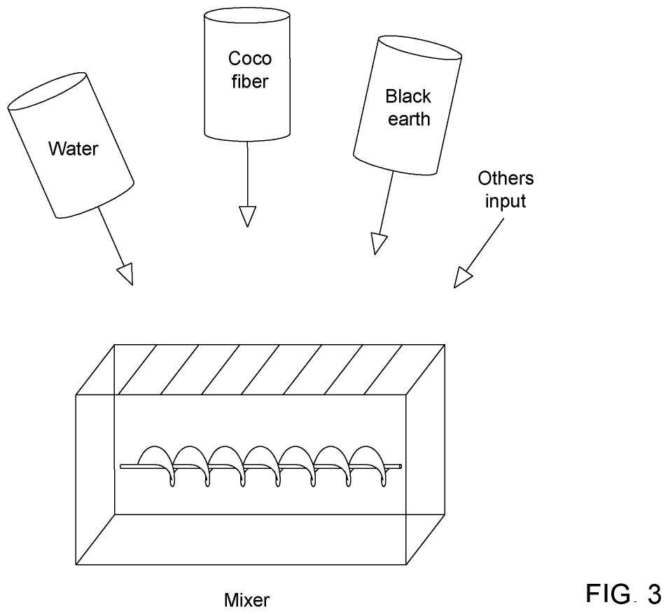

Referring to FIG. 2, the homogeneously distributed and wet growth premix can be formed by providing at least the organic material and water to a mixing unit 100. FIG. 3 shows an implementation where water, black earth, coconut fibers and additional components can be simultaneously mixed in a mixer to form the wet growth premix.

Homogeneous distribution can ensure that the network of the micropores and macropores for water and air will be evenly created within the growth medium upon further molding of the wet premix. The mixing is preferably performed without destroying the fibers of the growth premix. In some implementations, water can be added to produce the wet premix having 30 a 95 wt % humidity. In some implementations, the weight of water that is added to the growth premix can be between 50 and 100% of the weight of the growth premix. The humidity can be selected based on an optimal humidity ratio to activate a bonding capacity of the components of the growth premix (such as clays when present).

It should be noted that the growth premix that is produced can be a soil-enriched growth premix that includes a higher portion of soil than conventional substrates in the field of passive hydroponics. For example, the growth premix can include at least 60% of soil with respect to a total weight of the growth premix.

The method further includes molding the wet premix to a given shape and size (complementary to the shape of the recess of the container) to form the wet growth medium. Still referring to FIG. 2, the wet premix is further sent to a molding unit 102 where the wet premix is compacted into a mold of given shape and size to produce the wet growth medium. The given shape and size can be selected in accordance with the species of plant to be grown and the volume of the container recess. The compacting can be performed to allow the formation of the pore network that is necessary for capillary action and root growth.

The size of the growth medium can thus vary in accordance with the requirements of root growth for each plant and achieve maturity of any fruits. The volume of wet premix that is provided to form the growth medium upon molding can for example vary between 1.3 L and 2.5 L. The volume of the wet growth medium itself can vary in accordance with the compaction that is applied during molding of the substrate premix. For example, the volume of the growth medium for one plant of herbs can be at least 150 cm³ to 300cm³. For small fruits such as cherry tomatoes, the volume of the wet growth medium can be at least 1000 cm³ to 1200cm³. Such volume does not vary by more than 10%, preferably 5% when the wet growth medium is dried to produce the growth medium.

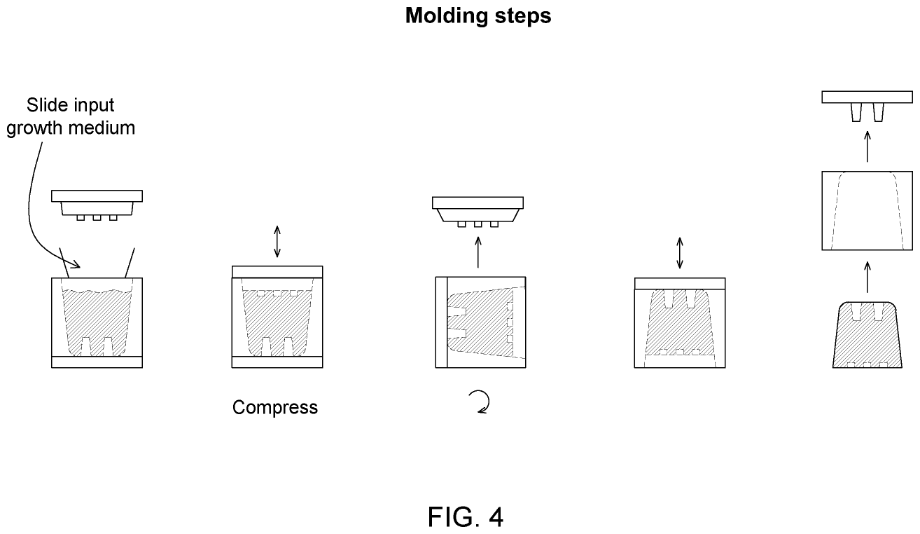

In some implementations, molding of the wet premix can include forming seed holes in a surface of the wet growth medium. Referring to FIG. 4, the molding can be performed with a potting machine including a mold 20 that shapes the wet premix and a compression plate 22 that compresses the shaped premix 16 into the mold 20. The compression plate 22 can include a head 220 having protrusions 221 to form the desired number, size and pattern of seed holes. In some implementations, the mold 20 can be rotated to have the same head or another head with different protrusions 222 of the compression plate 22 forming seed holes in two or more different surfaces of the shaped wet growth medium 16.

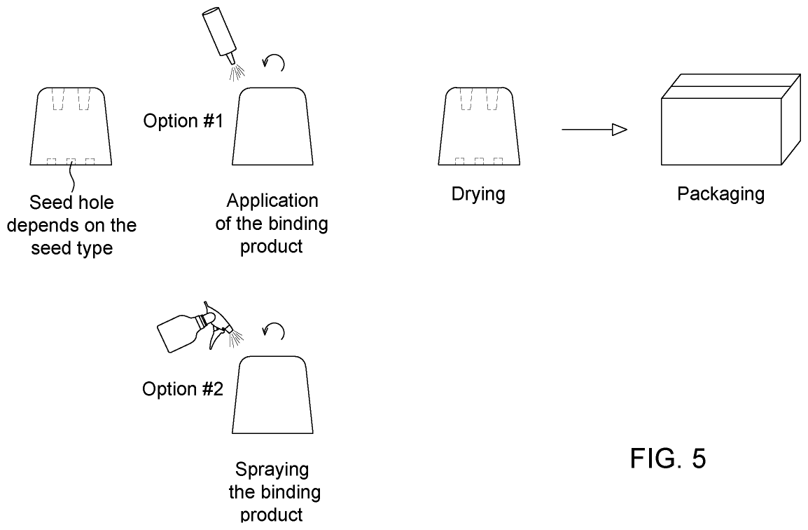

The method further includes binding the wet growth medium to maintain cohesion among the substrate premix once dried in the given shape and size of the growth medium. Referring to FIG. 2, the binding 104 can include forming a binding layer made of the binding material onto at least a portion of an exterior surface of the wet growth medium to for a wet growth substrate block. For example, at least a bottom surface and a side surface of the molded substrate premix can be covered with the binding layer. Referring to FIG. 5, application of the binding material can include spraying a solution of the binding material or applying the solution of the binding material to the desired surface of the wet growth medium by other available means. The spraying can be a low-pressure spraying not to damage the shape of the wet growth medium or destroy the pore network. The binding layer can be applied as a continuous layer. However, upon drying, the binding layer should remain permeable to water, and some discrete sections of the exterior surface of the growth medium can remain exposed. The binding material can further be selected to produce a non-sticky binding layer upon drying.

The method can include forming the solution by mixing the at least one binding agent with water. The method can further include adjusting a concentration of the at least one binding agent to form the solution.

Alternatively or in addition to the formation of the binding layer, the method can include mixing a binding material as an additional component of the growth premix before molding into the wet growth medium. The binding material forming the binding layer and the binding material being mixed as a component of the wet premix before molding can be same or different.

Referring to FIG. 2, the method can further include drying 106 of the wet growth substrate block to form the growth substrate block. The growth substrate block is considered as dried when its weight does not vary in three days or when the humidity level is at most 8%. The substrate block can be efficiently dried without exposition to high temperature that could be detrimental to the plant seed, for example. The temperature that is maintained during drying can be between 5 and 40° C. The drying can be performed as soon as the binding layer is applied onto the growth medium, especially when the growth medium includes fertilizing material, to remove substantially all water that could trigger premature release of micronutrients during storage of the growth substrate block and before the period of use of the growth substrate block for growing plants

The method can further include providing the at least one plant seed in an upper portion of the growth medium and at a given depth of the growth medium. For example, multiple seeds can be provided in a given volume of the upper part of the growth medium to have optimal spacing between plants. For example, the seeds of plant can be provided in the upper part of the growth medium to produce microgreens of the plant. In another example, spores of fungi can be provided as a mat of spores that is positioned in contact with an upper surface of the growth medium. Embedding the plant seed in the growth medium can be performed before or after forming the binding layer. In some implementations, the method can include providing the seeds in the seed holes that are formed at the surface of the growth substrate block. Optionally, the seeds can be added to a mixture of water and clay before being provided in the growth substrate block.

The method can further include maintaining the growth substrate block at a temperature preventing premature release of micronutrients during storage life. For example, the growth substrate block can be maintained at a temperature of at most 18° C., at most 17° C., at most 16° C. or at most 15° C. during storage. The method can further include maintaining a humidity of the growth substrate block below 3%, below 2%, below 1% or at 0% of the water absorption capacity.

The present techniques allow producing the growth medium based on a single mixing step, and avoid high temperature drying, while minimizing handling of the substrate block.

The substrate block that is prepared according to the techniques and components described herein is suited to sustain plant growth via capillary action by providing a balanced ratio of air to water (macropores/micropores). The structure of the growth medium allows for a tailored cationic exchange capacity, microporosity, microporosity, and capillary capacity (related to a tension in the growth medium). In addition, the binding layer of the substrate block allows maintaining cohesion of the substrate block during handling and transport. Such cohesion can be characterized by not crumbling when being up to 20% humid. The growth substrate block is designed to be sufficiently dense and rigid to provide support to the growing roots and retain the micro-elements/nutrients, the seeds and humidity within the growth substrate block. The growth medium can be characterized as having a density between 0.1 g/cm³ and 1 g/cm³ in a dried state (0% humidity).

Depending on the way the growth substrate block can be further conditioned in a packaging, the humidity level can be maintained for a given time during shelf storage and before being inserted in the recess of the container during its service lifetime. In absence of added water, the growth substrate block can remain usable up to at least 6 months, at least 1 year or at least 1.5 years of storage. The storage life expectancy can depend on the type of plant seed that is embedded in the substrate block. After its service lifetime for sustaining growth of the plant, the substrate block can be disposed in temperature conditions allowing biodegradability in at most 10 years, for example in compliance with the regulations of the Biodegradable Products Institute (BPI), thereby forming compost.

Even though implementations of the growth substrate block have been described in relation to plant growth, it should be noted that the nature and amounts of components of the growth substrate block can be adapted based on the present description to sustain growth of fungi, via replacement of the plant seeds with fungi spores, for example. Typical mushroom that could be grown in the present growth substrate block include for example oyster and shiitake.

It is worth mentioning that throughout the following description when the article “a” is used to introduce an element it does not have the meaning of “only one” it rather means of “one or more”. For instance, the growth substrate block according to the invention can be provided with one or more plant seed(s), or the container of the assembly can be provided with one or more self-watering recess(es), etc. without departing from the scope of the present invention. It is to be understood that where the specification states that a component, feature, structure, or characteristic “may”, “might”, “can” or “could” be included, that particular component, feature, structure, or characteristic is not required to be included.

In the above description, an embodiment or implementation is an example or implementation of the invention. The various appearances of “one embodiment,” “one aspect”, “an embodiment”, “some embodiments”, or “some implementations” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

1. A growth substrate block for sustaining the growth of a plant or fungi based on capillary watering, the growth substrate block comprising:
a growth medium including an organic material, the growth medium defining a network of micropores and macropores allowing water to flow by capillarity and air to circulate within the growth medium; and
a binding material provided as a binding layer onto at least a portion of an exterior surface of the growth medium to maintain cohesion of the growth medium.

2. The growth substrate block of claim 1, wherein the organic material is peat moss, chernozemic soil (black earth), compost, coconut husk chips, coconut fibers, wood fibers, hemp fibers, biochar or any mixtures thereof.

3. The growth substrate block of claim 1, wherein the growth medium further comprises at least one of a mineral material, a fertilizing material and a wetting agent.

4. The growth substrate block of claim 3, wherein the mineral material is sand, clay, lime, perlite, rock wool or any mixtures thereof.

5. The growth substrate block of claim 4, wherein the clay is vermiculite, diatomite, kaolinite, bentonite or any combination thereof.

6. The growth substrate block of claim 3, wherein the wetting agent is a media surfactant.

7. The growth substrate block of claim 3, wherein growth medium comprises the organic material, the mineral material, and the wetting agent.

8. The growth substrate block of claim 3, wherein the growth medium comprises soil, peat moss, coconut fibers, kaolinite, and perlite.

9. The growth substrate block of claim 3, wherein the growth medium further comprises the fertilizing material.

10. The growth substrate block of claim 9, wherein the fertilizing material is a slow-release fertilizer.

11. The growth substrate block of claim wherein the fertilizing material is an organic fertilizing material.

12. The growth substrate block of claim 11, wherein the organic fertilizing material is insect meal, animal manure of a combination thereof.

13. The growth substrate block of claim 1, wherein the binding material comprises at least one binding agent being latex, polylactic acid (PLA), clay, vinylic glue, rosin glue, sorbitol, molasses powder, Stabifix®, cardboard paste, collagen, oil epoxides, or any mixtures thereof. For example, the clay can be bentonite, kaolinite or any mixtures thereof.

14. The growth substrate block of claim 1, wherein the binding material can include or be a bio-glue resulting from radical polymerization of itaconic acid with and without glycerol, radical polymerization-polycondensation of itaconic acid with glycerol, or cationic and thermal polymerization of polyunsaturated vegetable oils.

15. The growth substrate block of claim 1, wherein the binding layer is provided on a side surface and a bottom surface of the growth medium.

16. The growth substrate block of claim 1, wherein the binding layer is permeable to water.

17. The growth substrate block of claim 1, wherein the growth medium comprises an additional binding agent that is homogeneously distributed within the growth medium.

18. The growth substrate block of claim 1, further comprising at least one plant seed.

19. The growth substrate block of claim 1, further comprising at least one spore of fungi.

20. The growth substrate block of claim 1, wherein the growth medium has a density between 0.1 g/cm³ and 1 g/cm³ (in a dried state).

21. The growth substrate block of claim 1, the growth medium can include at least 55 wt %, 65 wt %, 75 wt % or 80 wt % of the organic material.

22. The growth substrate block of claim 1, wherein the binding material represents at most 5 wt %, at most 3 wt %, at most 2 wt % or at most 1 wt % of a total weight of the growth medium.

23. The growth substrate block of claim 1, wherein the growth medium is biodegradable after a period of use of the growth substrate block upon exposure to temperature conditions allowing biodegradability.

24. The growth substrate block of claim 1, wherein the binding material is biodegradable after a period of use of the growth substrate block upon exposure to temperature conditions allowing biodegradability.

25. The growth substrate block of claim 1, being biodegradable after a period of use of the growth substrate block upon exposure to temperature conditions allowing biodegradability.

26. The growth substrate block of claim 1, wherein the growth substrate block is sized in accordance with dimensions of a root system at plant maturity.

27. The growth substrate block of claim 1, wherein a volume of the growth substrate block is between 250 cm³ and 2000cm³.

28. The growth substrate block of claim 1, wherein the growth substrate block has a parallelepipedal shape, a frustoconical shape, or a cylindrical shape.

29. A method to produce a growth substrate block sustaining the growth of a plant or fungi based on capillary watering, the method comprising:
forming a growth premix including an organic material;
mixing the growth premix to produce a homogeneously distributed growth premix;
adding water to the homogeneously distributed growth premix to form a wet premix;
molding the wet premix into a shape that is complementary to the self-watering recess of the container to produce a wet growth medium;
forming a binding layer made of a binding material onto at least a portion of an exterior surface of the wet growth medium to form a wet growth substrate block, and drying the wet growth substrate block to form the growth substrate block.

30. The method of claim 29, wherein the steps of forming the substrate premix and mixing the substrate premix are performed simultaneously.

31. The method of claim 29, or wherein mixing the growth premix and adding water to the homogeneously distributed growth premix are performed simultaneously.

32. The method of claim 29, wherein molding the wet premix comprises compacting the wet premix into a mold of given shape and size.

33. The method of claim 29, wherein molding the wet premix comprises forming seed holes in the surface of the wet growth medium.

34. The method of claim 29, wherein the forming of the growth premix comprises providing the organic material together with at least one of a mineral material, a fertilizing material and a wetting agent.

35. The method of claim 29, wherein forming the binding layer comprises spraying a solution comprising at least one binding agent onto the at least a portion of the exterior surface of the wet growth medium.

36. The method of claim 35, comprising forming the solution comprising the at least one binding agent by adjusting a concentration of the binding agent in the solution.

37. The method of claim 29, further comprising positioning at least one plant seed within an upper portion of the growth substrate block.

38. The method of claim 37, wherein the positioning of the at least one plant seed is performed after drying.

39. The method of claim 29, wherein the drying is performed to produce the growth substrate block at 0 to 3 % of a water absorption capacity thereof.

40. The method of claim 29, wherein the drying is performed at a temperature between 5 and 40° C.

41. The method of claim 29, further comprising maintaining a temperature of the growth substrate block at most 18° C. during a storage period.

42. The method of claim 29, wherein the growth substrate block is as defined in any one of claims 1 to 28.

43. A self-watering plant growth assembly comprising:
a container comprising a water tank that is supplied with water, a recess and a porous medium that provides water from the water tank into the recess via capillary action; and
a growth substrate block as defined in any one of claims 1 to 28, or as produced by the method as defined in any one of claims 29 to 42, which is inserted in the recess of the container to sustain plant growth upon receiving the water that is provided from the water tank via the porous medium.
